(19) United States
(12) Patent Application Publication
(10) Pub. No.: US 2022/0406279 A1
(43) Pub. Date: Dec. 22, 2022

(54) METHODS, INFORMATION PROCESSING DEVICE, AND IMAGE DISPLAY SYSTEM FOR ELECTRONIC MUSICAL INSTRUMENTS

(71) Applicant: CASIO COMPUTER CO., LTD., Tokyo (JP)

(72) Inventors: Masayuki HIROHAMA, Tokyo (JP); Shigeru KAFUKU, Tokyo (JP)

(73) Assignee: CASIO COMPUTER CO., LTD., Tokyo (JP)

(21) Appl. No.: 17/826,073

(22) Filed: May 26, 2022

(30) Foreign Application Priority Data
Jun. 21, 2021 (JP) 2021-102530

(51) Int. Cl. G10H 1/00; G06F 3/14

(52) U.S. Cl. CPC G10H 1/0008; G06F 3/14; G10H 2210/076; G10H 2220/005

(57) ABSTRACT

A method of determining a data output timing, performed by at least one processor in an information processing device for an electronic musical instrument includes, via the at least one processor: obtaining data of a first performance operation on the electronic musical instrument by a user; obtaining data of a second performance operation on the electronic musical instrument by the user; and determining the data output timing for outputting a data to the user based on a time interval between the first and second performance operations.

### BACKGROUND OF THE INVENTION

### Technical Field

The present invention relates to methods, information processing devices, and image display systems for electronic musical instruments.

### Background Art

A technology has been developed that analyzes MIDI (Musical Instrument Digital Interface) data generated by the user playing an electronic musical instrument, and that creates and displays video images that change corresponding to the performance and still images (pictures) that reflect the content of the performance.

For example, see Patent Document 1: Japanese Patent Application Laid-Open No. 2019-101168.

Practicing musical instruments is difficult, and many people get bored and give up on the way. In order to motivate not only advanced players, but also those who are standing at the entrance to playing musical instruments, it is effective to visualize music performances and use visual effects.

When moving images are dynamically generated/displayed along with the performance, music can be enjoyed from a new perspective.

### SUMMARY OF THE INVENTION

In an example of technology for visualizing a performance, a computer generates a moving image (first image) displayed in real time during the performance and a summary image (second image: final picture) displayed after the performance is completed. In this technology, it is difficult to determine when to display the final picture. At present, when a certain time (judgment time) has elapsed since the last note-off event, it is determined that the performance has ended and the final picture is displayed. However, for children who are not good at playing, the keystroke interval becomes long and the final picture may appear even though the performance still continues.

It was disappointing when the final picture came out while the child is still playing hard. If the determination time were set long to avoid this, it would take time from the end of the performance until the final picture appears, which rather puts stress on the user.

For instruments played by many unspecified users like a street piano, it is desirable to be able to set this determination time appropriately according to the playing situation.

In one embodiment of the present invention, a processor in the information processing apparatus determines the output timing of the data to be output after the end of the performance, based on the interval between a first performance operation and a second performance operation.

According to this aspect of the invention, for example, the end of a performance can be accurately determined, which makes the performance even more enjoyable.

Additional or separate features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, in one aspect, the present disclosure provides a method of determining a data output timing, performed by at least one processor in an information processing device for an electronic musical instrument, the method comprising, via the at least one processor: obtaining data of a first performance operation on the electronic musical instrument by a user; obtaining data of a second performance operation on the electronic musical instrument by the user; and determining the data output timing for outputting a data to the user based on a time interval between the first and second performance operations.

In another aspect, the present disclosure provides an information processing device for an electronic musical instrument, comprising: an input/output interface; and at least one processor, wherein the at least one processor perform the following: obtaining, via the input/output interface, first performance data corresponding to a first performance operation on the electronic musical instrument by a user and second performance data corresponding to a second performance operation on the electronic musical instrument by the user; obtaining a time interval between the first performance operation and the second performance operation based on the first performance data and the second performance data; and determining a data output timing for outputting a data to the user based on the obtained time interval.

In another aspect, the present disclosure provides an image display system, comprising: an electronic musical instrument; and a display device, wherein the electronic musical instrument sends, to the display device, first performance data corresponding to a first performance operation on an electronic musical instrument by a user and second performance data corresponding to a second performance operation on the electronic musical instrument by the user, and wherein the display device performs the following: obtaining the first performance data and the second performance data; obtaining a time interval between the first performance operation and the second performance operation based on the first performance data and the second performance data; determining a data output timing for outputting an image data to the user based on the obtained time interval; and displaying the image data in accordance with the determined data output timing.

It is to be understood that both the foregoing general description and the following detailed description are exemplary and explanatory, and are intended to provide further explanation of the invention as claimed.

### BRIEF DESCRIPTION OF THE DRAWINGS

FIG. 1 is a diagram showing an example of a performance image display system according to an embodiment.

FIG. 2 is a diagram showing an example of an image display system in which a tablet is combined with a keyboard instrument.

FIG. 3 is a block diagram showing an example of the digital keyboard 1 according to the embodiment.

FIG. 4 is a functional block diagram showing an example of the tablet 3.

FIG. 5 is a flowchart showing an example of a processing procedure of the tablet 3.

FIG. 6 is a diagram showing one musical score example.

FIG. 7 is a diagram showing an example of a first image created from the musical score example of FIG. 6.

FIG. 8 is a diagram showing an example of a second image created from the musical score example of FIG. 6.

FIG. 9 is a flowchart showing an example of a processing procedure in step S4 of FIG. 5.

FIG. 10 is a diagram for explaining the calculation of the note interval in step S42 of FIG. 9.

FIG. 11 is a flowchart showing an example of a processing procedure related to the update of the determination period update coefficient α.

### DETAILED DESCRIPTION OF EMBODIMENTS

Hereinafter, embodiments of the present invention will be described with reference to the drawings.

### Structure

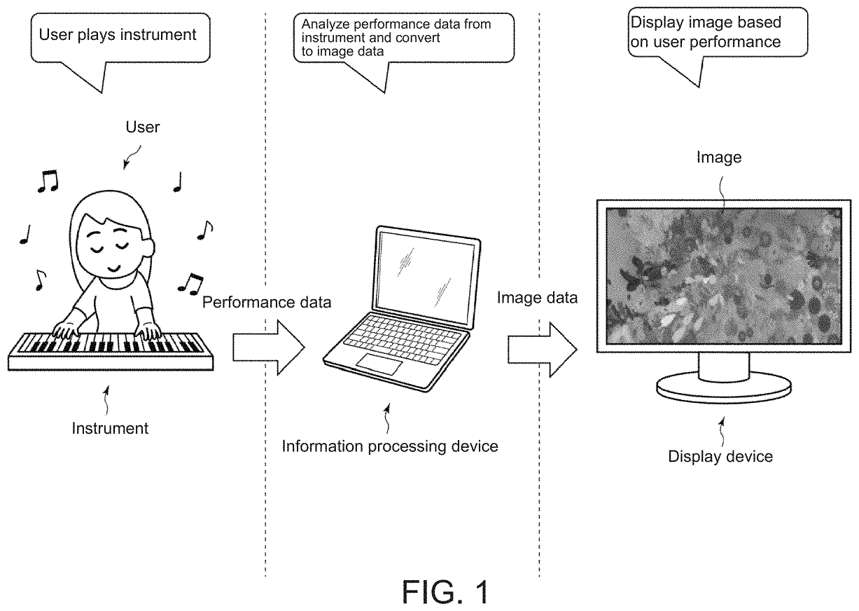

FIG. 1 is a schematic diagram showing an example of an image display system according to an embodiment. The image display system shown in FIG. 1 draws an image (picture) in real time according to the performance of the user (performer). This type of image display system analyzes performance data acquired from an electronic musical instrument or the like that can output the user's performance as performance data (for example, MIDI data), and generates an image based on the analysis result.

In FIG. 1, the image display system includes an electronic musical instrument, an information processing device, and a display device.

The electronic musical instrument generates performance data (for example, MIDI data) from the user's performance, and outputs the performance data to the information processing device. The information processing device analyzes the received performance data and generates image data. The information processing device is, for example, a tablet or a PC (personal computer). The display device displays an image generated by the information processing device.

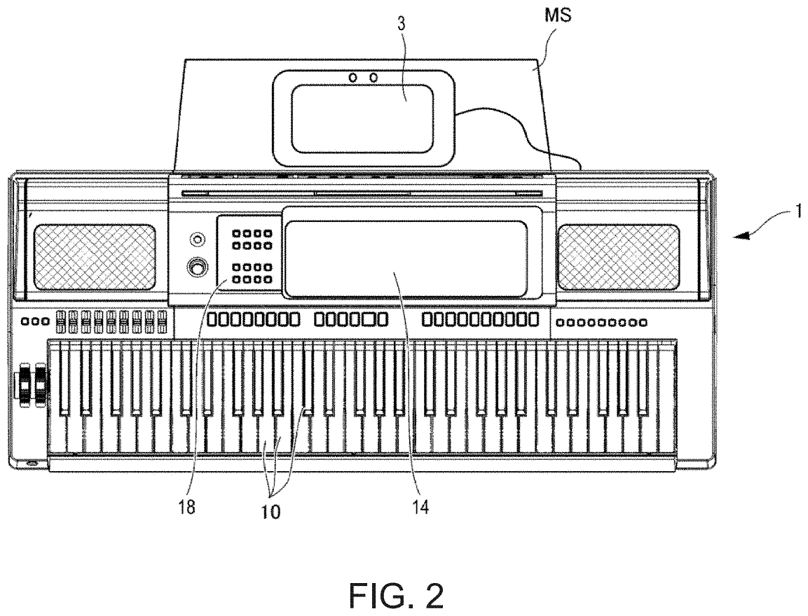

FIG. 2 is a diagram showing an example of an image display system in which a tablet is combined with a keyboard instrument. The system includes a digital keyboard 1 and a tablet 3 connectable to the digital keyboard 1. The digital keyboard 1 is, for example, an electronic keyboard instrument such as an electronic piano, a synthesizer, or an electronic organ.

The digital keyboard 1 includes a display unit 14, an operation unit 18, and a music stand MS in addition to a plurality of keys 10 arranged on the keyboard. As shown in FIG. 2, the tablet 3 connected to the digital keyboard 1 can be placed on the music stand MS to display a score or to be used as a user interface.

The key 10 is an operator for the performer to specify the pitch. When the performer presses/releases the key 10, the digital keyboard 1 generates/mutes the sound corresponding to the designated pitch. Pressing and releasing keys are examples of performance operations. Each can be regarded as a performance operation individually, or a set of key press/release operations can be regarded as one performance operation. Alternatively, only the key press may be captured and counted as an individual performance operation, or only the release key may be regarded as a performance operation. For example, an event that triggers the generation of performance data can be regarded as a performance operation. All actions that generate performance data may be regarded as performance operations, or only actions that generate certain types of performance data (note-on, note-off, etc.) may be regarded as performance operations.

The display unit 14 is provided with, for example, a liquid crystal display (LCD) with a touch panel, and displays a message associated with the operation of the operation unit 18 by the performer, for example. When the display unit 14 has a touch panel function, the display unit 14 can play a part of the function of the operation unit 18.

The operation unit 18 has operation buttons, dials, and the like for the performer to make various settings and the like. The user can perform various setting operations such as volume adjustment by operating the operation buttons and dials.

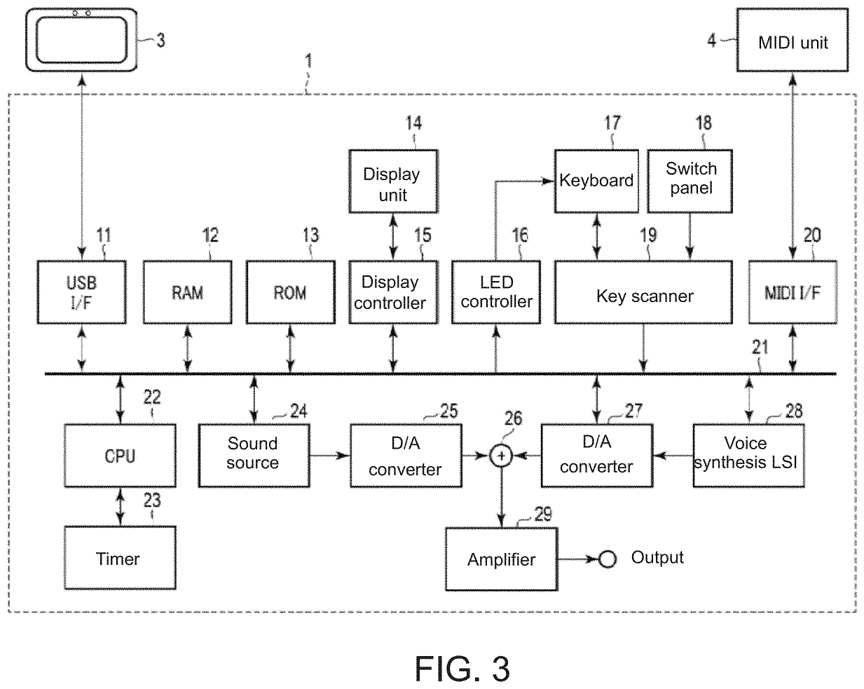

FIG. 3 is a block diagram showing an example of the digital keyboard 1 according to the embodiment. The digital keyboard 1 includes a USB interface (I/F) 11, a RAM (Random Access Memory) 12, a ROM (Read Only Memory) 13, a display unit 14, a display controller 15, an LED (Light Emitting Diode) controller 16, a keyboard 17, an operation unit (switch panel) 18, a key scanner 19, a MIDI interface (I/F) 20, a system bus 21, a CPU (Central Processing Unit) 22, a timer 23, a sound source 24, a digital/analog (D/A) converter 25, a mixer 26, a D/A converter 27, a voice synthesis LSI 28, and an amplifier 29. Here, the sound source 24 and the voice synthesis LSI 28 are realized as, for example, a DSP (Digital Signal Processor).

The CPU 22, the sound source 24, the voice synthesis LSI 28, the USB interface 11, the RAM 12, the ROM 13, the display controller 15, the LED controller 16, the key scanner 19, and the MIDI interface 20 are connected to the system bus 21.

The CPU 22 is a processor that controls the digital keyboard 1. That is, the CPU 22 reads the program stored in the ROM 13 into the RAM 12 as a working memory and executes it to realize various functions of the digital keyboard 1. The CPU 22 operates according to the clock supplied from the timer 23. The clock is used, for example, to control the sequences of automatic performance and automatic accompaniment.

The ROM 13 stores programs, various setting data, automatic accompaniment data, and the like. The automatic accompaniment data may include preset rhythm patterns, chord progressions, bass patterns, melody data such as obbligatos, and the like. The melody data may include pitch information of each note, sound production timing information of each note, and the like.

The sound production timing of each note may be specified by interval time between each sound generation, or by the elapsed time from the start of the song that is being automatically performed. Tick is often used as the unit of time. 1 Tick is a unit used in popular sequencers based on the tempo of a song. For example, if the resolution of the sequencer is 480, 1/480 of the quarter note time is 1 Tick.

The automatic accompaniment data may be stored in an information storage device or an information storage medium (not shown) other than the ROM 13. The format of the automatic accompaniment data may conform to the file format for MIDI.

The display controller 15 is an IC (Integrated Circuit) that controls the display state of the display unit 14. The LED controller 16 is, for example, an IC. The LED controller 16 illuminates the keys of the keyboard 17 according to instructions from the CPU 22 to navigate the performance of the performer.

The key scanner 19 constantly monitors the key press/release state of the keyboard 17 and the switch operation state of the operation unit 18. Then, the key scanner 19 conveys the states of the keyboard 17 and the operation unit 18 to the CPU 22.

The MIDI interface 20 receives a MIDI data (performance data or the like) from an external device such as the MIDI device 4, and outputs a MIDI data to the external device. The digital keyboard 1 can send and receive MIDI data and music files to and from an external device using an interface such as USB (Universal Serial Bus). The received MIDI data is passed to the sound source 24 via the CPU 22. The sound source 24 generates a sound according to the tone color, volume (velocity), timing, etc., specified in the MIDI data.

The MIDI data (MIDI message) includes information such as pitch number and tone number corresponding to the key 10, information indicating timing such as note-on and note-off, intensity information called velocity, and various control information. That is, the MIDI data can represent any and all information about the performance of the music piece.

The sound source 24 is, for example, a so-called GM sound source that conforms to the GM (General MIDI) standard. With this type of sound source, the tone color can be changed by giving a program change as a MIDI message included in the MIDI data. Also, the default effect can be controlled by giving a control change.

The sound source 24 has, for example, the ability to produce sounds of up to 256 voices at the same time. The sound source 24 reads, for example, musical sound waveform data from a waveform ROM (not shown) and outputs the digital musical sound waveform data to the D/A converter 25. The D/A converter 25 converts the digital musical sound waveform data into an analog musical sound waveform signal.

When the voice synthesis LSI 28 is given the text data of the lyrics and the information about the pitch as the singing voice data from the CPU 22, the voice data of the corresponding singing voice is synthesized and output to the D/A converter 27. The D/A converter 27 converts the voice data into an analog voice waveform signal.

The mixer 26 mixes the analog musical sound waveform signal and the analog voice waveform signal to generate an output signal. This output signal is amplified by the amplifier 29 and output from an output terminal such as a speaker or a headphone out.

The tablet 3 is connected to the system bus 21 via the USB interface 11. The tablet 3 can acquire MIDI data (performance data) generated by playing the digital keyboard 1 via the USB interface 11.

Further, a storage medium or the like (not shown) may be connected to the system bus 21 via the USB interface 11. Examples of the storage medium include a USB memory, a flexible disk drive (FDD), a hard disk drive (HDD), a CD-ROM drive, a magneto-optical disk (MO) drive, and the like. When the program is not stored in the ROM 106, the program may be stored in the storage medium and read into the RAM 105 so that the CPU 111 can execute the same operations as when the program is stored in the ROM 106.

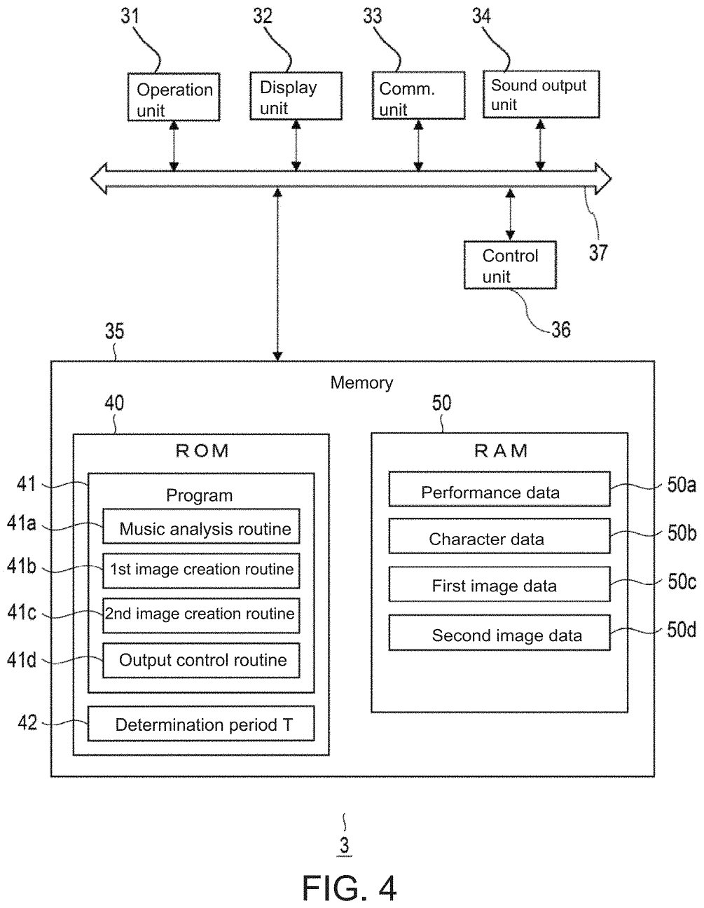

FIG. 4 is a functional block diagram showing an example of the tablet 3. The tablet 3 is a portable information processing device, and an application for generating and outputting an image reflecting a performance using the digital keyboard 1 has been installed. Further, the tablet 3 may include a sequencer or the like that receives MIDI data from the digital keyboard 1 so as to produce the song data.

The tablet 3 mainly includes an operation unit 31, a display unit 32, a communication unit 33, a sound output unit 34, a memory 35, and a control unit 36 (CPU). Each unit (operation unit 31, display unit 32, communication unit 33, sound output unit 34, memory 35, and control unit 36) is communicably connected by a bus 37, and requisite data can be exchanged between the units.

The operation unit 31 includes, for example, switches such as a power switch for turning on/off the power. The display unit 32 has a liquid crystal monitor with a touch panel and displays an image. Since the display unit 32 also has a touch panel function, it can perform a part of the functions of the operation unit 31.

The communication unit 33 includes a wireless unit and a wired unit for communicating with other devices and the like. In this embodiment, it is connected to the digital keyboard 1 by wire such as a USB cable, whereby the tablet 3 can exchange various digital data with the digital keyboard 1.

The sound output unit 34 includes a speaker, an earphone jack, and the like, and outputs analog audio and music sounds and/or outputs an audio signal.

The control unit 36 includes a processor such as a CPU and controls the tablet 3. The CPU of the control unit 36 executes various processes according to the control program stored in the memory 35 and the installed applications.

The memory 35 includes a ROM 40 and a RAM 50.

The ROM 40 stores, for example, a program 41 executed by the control unit 36, various data tables, and the like. In particular, in this embodiment, the determination period T related to the determination of the end of the performance is stored in the storage area 42 of the ROM 40.

The RAM 50 stores data necessary for executing the program 41. The RAM 50 also functions as temporary storage areas for data created by the control unit 36, MIDI data sent from the digital keyboard 1, data for launching an application, and the like. In this embodiment, in addition to the performance data 50a including MIDI data, the RAM 50 stores character data 50b, first image data 50c, and second image data 50d.

In this embodiment, the program 41 includes a music analysis routine 41a, a first image creation routine 41b, a second image creation routine 41c, and an output control routine 41d.

The music analysis routine 41a acquires each performance data generated one after another according to the performance of the digital keyboard 1 and stores the performance data 50a in the RAM 50. Further, the music analysis routine 41a performs music analysis mainly based on the pitch data included in the performance data 50a, and performs tonality, chord type, sound name determination, and the like of the music piece.

The method for music analysis or the procedure for determining tonality, code type, etc., is not particularly limited, but for example, the technique disclosed in Japanese Patent No. 3211839 can be used.

The first image creation routine 41b creates moving image data to be displayed in real time during the performance based on the result of the music analysis. The created moving image data is temporarily stored in the RAM 50 as the first image data 50c, then immediately read out and displayed on the display unit 32.

The second image creation routine 41c creates a still image to be displayed as a summary after the performance is completed, based on the result of the music analysis. The moving image data of the created still image is temporarily stored in the RAM 50 as the second image data 50d, and then output (read out) at an appropriate timing and displayed on the display unit 32.

The output control routine 41d determines the timing of outputting the second image data based on the timing at which each performance data from the digital keyboard 1 is generated or the interval between the timings at which the performance data is acquired.

### Operation

Next, the operation of the above configuration will be described. Hereinafter, it is assumed that the tablet 3 is communicably connected to the digital keyboard 1. Further, it is assumed that an application for displaying an image on the display unit 32 of the tablet 3 (FIG. 4) has been launched in the tablet 3.

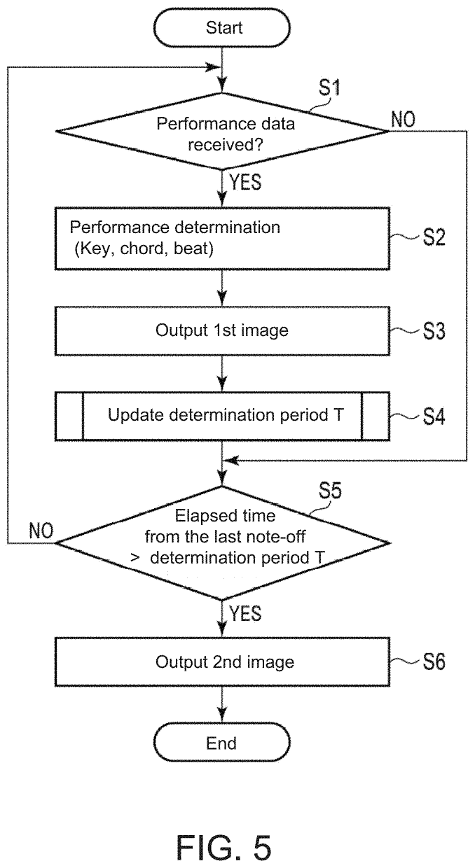

FIG. 5 is a flowchart showing an example of the processing procedure of the tablet 3. In FIG. 5, the control unit 36 (CPU) of the tablet 3 waits for the input of performance data from the digital keyboard 1 (step S1). If the performance data is input in step S1 (Yes), the control unit 36 executes a performance determination process (step S2). In step S2, the control unit 36 determines, for example, the key of the song being played (for example, 24 types from C major to B minor), the chord type (for example, major, minor, sus4, aug, dim, 7^{th}, etc.), the beat, and the like based on the acquired performance data. The determination result obtained here is reflected in the first image.

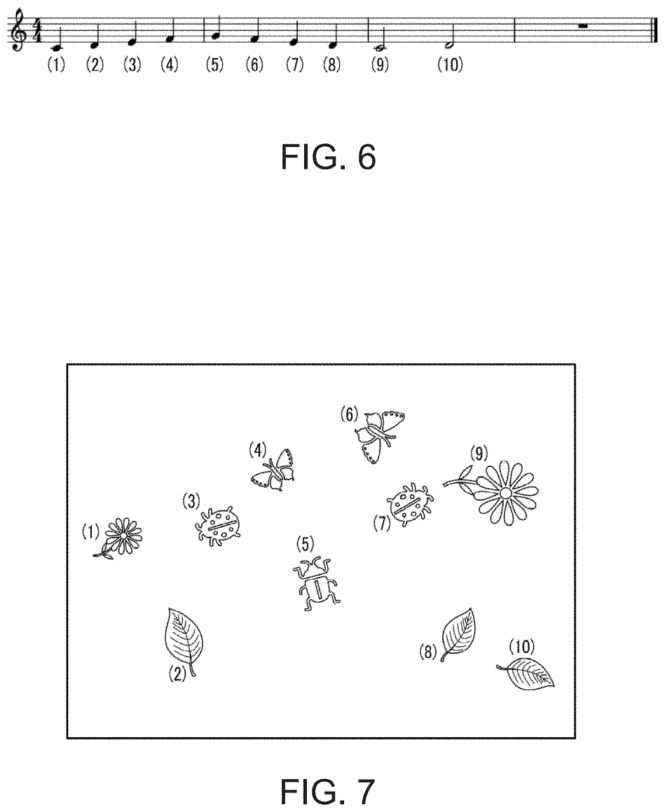

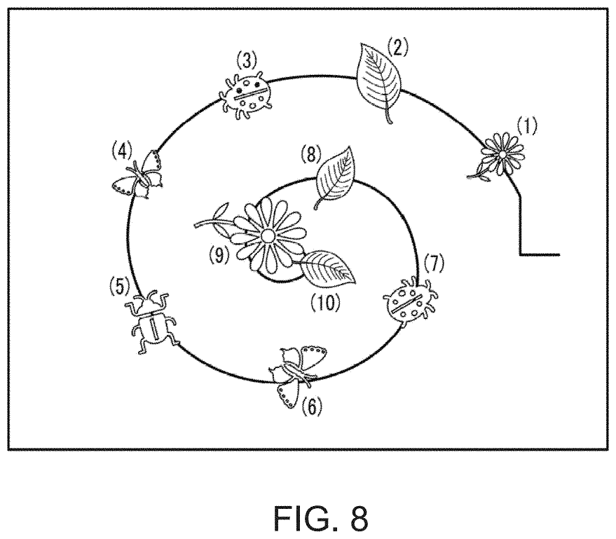

FIG. 6 is a diagram showing one musical score example. For example, when a performance as shown in FIG. 6 is performed, as shown in FIG. 7, the characters of flowers (1), leaves (2), ladybugs (3), and butterflies (4) appear one after another in the order of Do Re Mi, Fa, . . . , thereby forming the first image. When the end of the performance is determined, each character is arranged on a spiral orbit, for example, as shown in FIG. 8, and becomes the second image.

Returning to FIG. 5, the explanation will be continued. The control unit 36 generates a first image based on the result of the performance determination process and outputs it to the display unit 32 (step S3).

Next, the control unit 36 performs a process of updating the determination period T based on the result of the performance determination process (step S4). It was

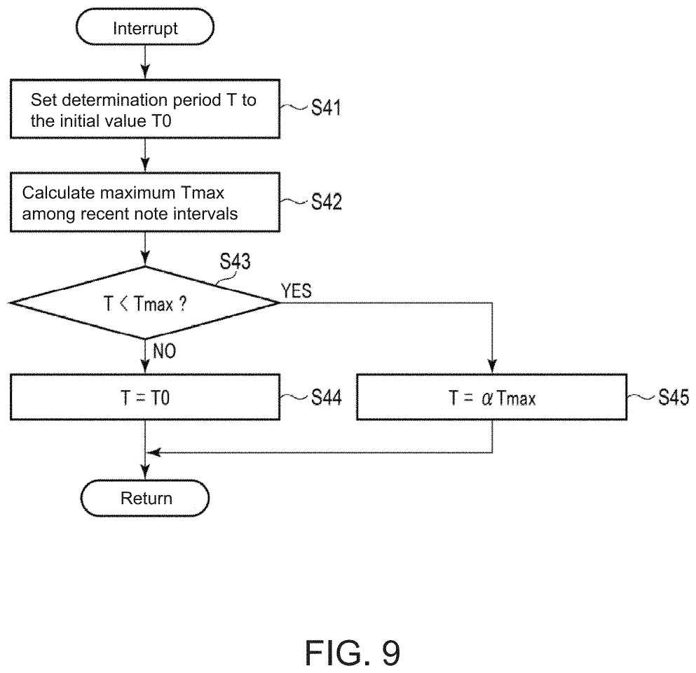

FIG. 9 is a flowchart showing an example of the processing procedure in step S4. When the determination period update process in step S4 is called, a software interrupt occurs. Then, the control unit 36 first sets the determination period T to the initial value T0 (step S41). For example, 5 seconds is set as the initial value T0. Next, the control unit 36 calculates the maximum value Tmax of the multiple recent note intervals (step S42). That is, in this step, the control unit 36 acquires the note-on times of X number (for example, 4) of sounds retroactively from the most recent note-on time, calculates each time interval, and obtains the maximum value Tmax among these recent time intervals.

Next, the control unit 36 compares the determination period T with Tmax (step S43), and if the statement “T is smaller than Tmax (T<Tmax)” is FALSE (NO in step S43), that is, if there is no recent time period that exceeds T, then T=T0 remains (step S44), and the processing procedure returns to the origin (return).

On the other hand, if (T<Tmax) is TRUE in step S43 (YES), that is, if one of the recent note intervals exceeds the determination period T, Tmax is multiplied by a determination period update coefficient α and substituted for T (step S45), and the processing procedure returns to the origin (return). Here, the value of the coefficient α may be 1.1, which corresponds to making the determination period T longer than the default. Further, the value of the coefficient α may be updated to different values depending on the performance situation, which will be described below.

Return to FIG. 5, when there is no input of performance data in step S1 (NO) or when step S4 is completed, the control unit 36 determines the end (step S5). In this embodiment, the end determination is performed by comparing the determination period T as a reference value with the elapsed time from the last note-off. That is, when the elapsed time from the last note-off becomes longer than the determination period T, it is determined that the performance has ended (YES). If NO in step S5, the processing procedure returns to step S1 again until a YES determination is made.

During the performance, the processes of steps S1 to S5 are repeated, and when the performance is completed (YES is set in step S5), the control unit 36 creates a second image that reflects the analysis result of the accumulated performance data 50a, and displays the second image to the display unit 32 (step S6).

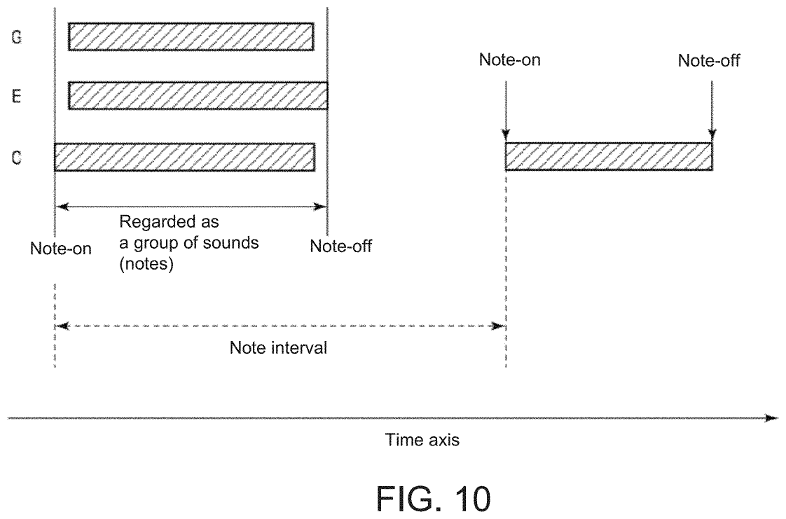

FIG. 10 is a diagram for explaining the calculation of the note interval in step S42 of FIG. 9. In this embodiment, the “note interval” means the period from the previous note-on to the next note-on. Here, sounds (notes) that overlap in time are treated as a group of sounds (notes).

For example, when multiple keys are pressed at once like playing a chord, strictly speaking, the note-on time of each case is often slightly different. As shown in FIG. 10, even if the C sound, E sound, and G sound of the C chord having C, E, and G as constituent sounds are slightly deviated in time, if the deviation amount is within a default value, these are grouped together, and are regarded such that note-on and note-off occur once each. For example, the key press time of the note pressed first in the group is set to the note-on, and the key release time of the note that was last released is set to the note-off. Then, the note interval is set to extend up to the note-on timing of the next note. The note-on of a sound can literally be counted as the key press time of that sound.

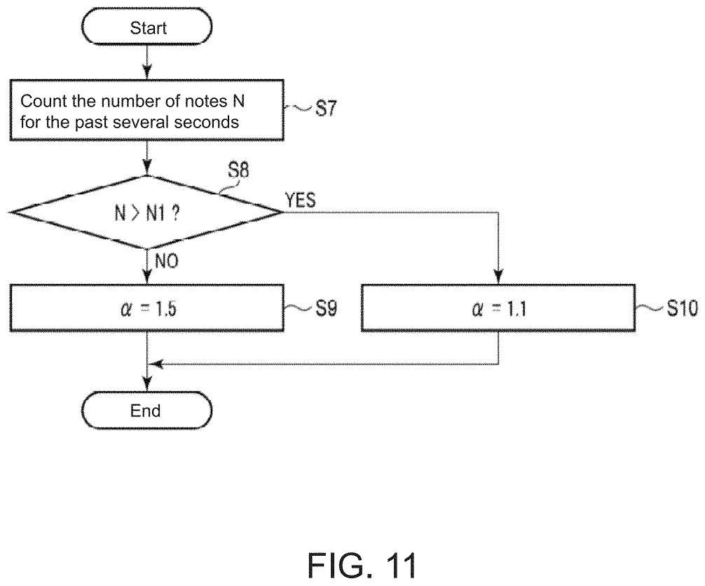

FIG. 11 is a flowchart showing an example of a processing procedure related to updating the update coefficient α for the determination period, which is a reference value for determining the output timing of the second image data. In FIG. 11, the control unit 36 counts the number of notes N for the past several seconds (for example, 8 seconds) from the current time point (step S7) and compares it with a predetermined threshold value N1 (for example, 5) (step S8). If N is greater than the threshold N1 (YES), 1.1 is assigned to a (step S10). On the other hand, if N is equal to or less than the threshold value N1 (NO), a value larger than 1.1, for example, 1.5, is assigned to a (step S9).

If it is determined in step S8 that the number of notes generated in the performance for the past few seconds is small, this means that the performance is likely to be unstable or slow. Therefore, in such a case, α is set to a large value so that the determination period T becomes long. Conversely, if the number of notes for the past few seconds is large, a is set to a small value.

That is, when the number of performance data generated or acquired within the set period does not reach the threshold value, the control unit 36 delays the output timing of the second image data more than when the number of performance data reaches the threshold value. The threshold is not limited to a single value N1. A plurality of values, N1, N2, N3, . . . , may be set and α may be gradually changed in several stages accordingly.

### Effects

As described above, in this embodiment, the timing of outputting the second image is controlled for each performance based on the result of music analysis of the performance data. For example, when playing a song with a fast tempo, the second image is output at an earlier timing from the stop of the performance than when playing a song with a slow tempo. On the other hand, when the beginner is playing slowly at a slow tempo, the time from the stop of the performance to the display of the second image becomes long.

Because of this, it is possible to output the second image at an appropriate timing after the end of the performance, not at a fixed timing. In other words, it is possible to prevent the final picture from appearing even though the performance has not ended, and to avoid a situation where the final picture does not appear promptly even after the performance has ended.

That is, according to this embodiment, it becomes possible to accurately determine the end of the performance. Therefore, it becomes possible to provide programs, electronic devices, methods, and image display systems that enhance the experience of visualizing music performances and that make playing and practicing musical instruments even more enjoyable without discouraging users from practicing.

The present invention is not limited to the above embodiment, and various modifications are possible, examples of which are described below.

### Modification Example 1

If the stability of the performance can be expected to some extent, an average value may be used instead of the maximum value of the recent note intervals in step S42 of FIG. 9.

### Modification Example 2

As a condition for determining the update of the predetermined time in step S42, an indicator that indicates performance instability may be used instead of the maximum value (or average value) of the recent note intervals. As such an indicator, determinations of a non-musical performance, tempo instability, or the like may be used.

For example, a determination that the performance operation is non-musical can be made on the basis of a certain combination of the pitch data detected at about same timing or on the basis of repeated occurrences of a certain combination of the pitch data during a set period, such as when a chord cannot be determined by music analysis (when the chord determination fails) and the number of times a chord cannot be determined exceeds a specified number, or when the simultaneous pressing of 5 or more of adjacent white keys is detected

When such a non-musical judgment is used, the condition (condition A) that the non-musical judgment occurs a specified number of times (for example, 3 times) or more within the last few beats (for example, 8 beats) can be considered for the update of the determination period T.

The logical product (AND) of this condition A and the “determination based on the calculated value of the recent note intervals (condition B), as described with reference to step S42 above, may be taken, and the determination period T may be updated when the logical product is TRUE.

### Modification Example 3

If it is desirable to use the tempo of the song more directly as a condition for determining the end of performance, the following can be considered. That is, the control unit 36 determines the tempo of the performance based on the performance data acquired from the digital keyboard 1. Then, when the determined tempo is a second tempo that is slower than a first tempo, the output timing for outputting the second image determined for the second tempo is made later in time than the output timing determined in the case of the first tempo.

### Modification Example 4

A method of confirming the movement of the performer may also be used as a technique for directly determining the end of the performance. That is, by installing a camera or the like that can detect the movement of the performer, for example, by determining that the player has stood up from the chair, the final picture (second image) may be displayed regardless of the time elapsed since the last note-off.

As described above, in at least some of the aspects of the present invention, the processor 36 of the information processing device (display device) 3 determines the output timing of the data to be output after the end of the performance based on the interval between the first performance operation and the second performance operation on the keyboard 17 of the electronic musical instrument 1 by the user. In an embodiment, this interval is calculated based on the acquisition timing of the note data acquired on the information processing apparatus 3 side in response to the first performance operation on the electronic musical instrument 1 side, and the acquisition timing of the note data acquired on the information processing apparatus 3 side according to the second performance operation that occurs after the first performance operation. The interval between the first performance operation and the second performance operation may be calculated by any appropriate method.

It will be apparent to those skilled in the art that various modifications and variations can be made in the present invention without departing from the spirit or scope of the invention. Thus, it is intended that the present invention cover modifications and variations that come within the scope of the appended claims and their equivalents. In particular, it is explicitly contemplated that any part or whole of any two or more of the embodiments and their modifications described above can be combined and regarded within the scope of the present invention.

What is claimed is:

1. A method of determining a data output timing, performed by at least one processor in an information processing device for an electronic musical instrument, the method comprising, via the at least one processor:
obtaining data of a first performance operation on the electronic musical instrument by a user;
obtaining data of a second performance operation on the electronic musical instrument by the user; and
determining the data output timing for outputting a data to the user based on a time interval between the first and second performance operations.

2. The method according to claim 1, wherein the data to be output to the user in accordance with the data output timing includes an image data.

3. The method according to claim 1, wherein the determining the data output timing includes changing a reference value that is used in determining the data output timing in accordance with said time intervals.

4. The method according to claim 1, wherein the determining the data output timing includes:
detecting a tempo based on first performance data generated based on the first performance operation and second performance data generated based on the second performance operation; and
determining the data output timing such that when the detected tempo is a second tempo that is slower than a first tempo, the determined data output timing for the second tempo is made later in time than the data output timing that would be determined for the first tempo.

5. The method according to claim 1, wherein the determining the data output timing includes:
determining whether or not performance operations by the user are musical;
determining the data output timing based on the determination result of whether or not the performance operations by the user are musical.

6. The method according to claim 1, wherein the determining the data output timing includes:
when a number of performance data generated or obtained during a set period does not reach a threshold, making the data output timing later in time than when the number of performance data generated or obtained during the set period reaches the threshold.

7. The method according to claim 1, wherein the data output timing is determined based on time intervals with respect to one or more performance operations in addition to the first and second performance operations.

8. An information processing device for an electronic musical instrument, comprising:
an input/output interface; and
at least one processor,
wherein the at least one processor perform the following:
obtaining, via the input/output interface, first performance data corresponding to a first performance operation on the electronic musical instrument by a user and second performance data corresponding to a second performance operation on the electronic musical instrument by the user;
obtaining a time interval between the first performance operation and the second performance operation based on the first performance data and the second performance data; and
determining a data output timing for outputting a data to the user based on the obtained time interval.

9. The information processing device according to claim 8, wherein the data to be output to the user in accordance with the data output timing includes an image data

10. The information processing device according to claim 8, wherein in determining the data output timing, the at least one processor changes a reference value that is used in determining the data output timing in accordance with said time interval.

11. The information processing device according to claim 8, wherein in determining the data output timing, the at least one processor performs the following:
detecting a tempo based on the first performance data and the second performance data; and
determining the data output timing such that when the detected tempo is a second tempo that is slower than a first tempo, the determined data output timing for the second tempo is made later in time than the data output timing that would be determined for the first tempo.

12. The information processing device according to claim 8, wherein in determining the data output timing, the at least one processor performs the following:
determining whether or not performance operations by the user are musical;
determining the data output timing based on the determination result of whether or not the performance operations by the user are musical.

13. The information processing device according to claim 8, wherein in determining the data output timing, the at least one processor performs the following:
when a number of performance data generated or obtained during a set period does not reach a threshold, making the data output timing later in time than when the number of performance data generated or obtained during the set period reaches the threshold.

14. An image display system, comprising:
an electronic musical instrument; and
a display device,
wherein the electronic musical instrument sends, to the display device, first performance data corresponding to a first performance operation on an electronic musical instrument by a user and second performance data corresponding to a second performance operation on the electronic musical instrument by the user, and
wherein the display device performs the following:
obtaining the first performance data and the second performance data;
obtaining a time interval between the first performance operation and the second performance operation based on the first performance data and the second performance data;
determining a data output timing for outputting an image data to the user based on the obtained time interval; and
displaying the image data in accordance with the determined data output timing.
